(19) United States
(12) Patent Application Publication
(10) Pub. No.: US 2025/0010772 A1
(43) Pub. Date: Jan. 9, 2025

(54) SEAT TRIM ELEMENT AND VEHICLE SEAT

(71) Applicant: Adient US LLC, Plymouth, MI (US)

(72) Inventors: Claudia SCHMIDT, Kerpen (DE); Tamas KARACSONYI, Haan (DE); Sven OLDACH, Remscheid (DE); Andrew BEDWIN, Langenfeld (DE); Edwin MENDES, Leverkusen (DE)

(73) Assignee: Adient US LLC, Plymouth, MI (US)

(21) Appl. No.: 18/740,591

(22) Filed: Jun. 12, 2024

(30) Foreign Application Priority Data
Jul. 6, 2023 (DE) 10 2023 206 423.5

(51) Int. Cl. B60N 2/58

(52) U.S. Cl. CPC B60N 2/58

(57) ABSTRACT

A seat trim element, formed as a three-dimensionally shaped seat covering element and/or three-dimensionally shaped seat cushion element of a vehicle seat, where at least one three-dimensionally shaped insert produced by a thermoforming process is provided and can be attached or is detachably or interchangeably attached to the seat trim element.

### FIELD

The invention relates to a seat trim element having the features of the preamble of claim 1 and to a vehicle seat.

### BACKGROUND

Seat trim elements for vehicle seats are generally known from the prior art. Seat trim elements can be, for example, seat covering elements, in particular seat covers, or seat upholstery elements, in particular upholstery shells. The seat upholstery elements are usually arranged on a support structure, such as a support frame of the vehicle seat. The seat upholstery element can, for example, be arranged on the seat upholstery element and joined to it. It is also known to shape such seat covering elements three-dimensionally to enable a molded seat contour.

### SUMMARY

The problem addressed by the invention is that of improving a seat trim element of the type mentioned at the outset, in particular to make it variable, and to provide a corresponding vehicle seat.

This first-mentioned problem is solved in accordance with the invention by a seat trim element having the features of claim 1. The second-mentioned problem is solved by a vehicle seat having the features of claim 8.

Advantageous embodiments, which can be used individually or in combination with one another, are the subject of the dependent claims.

The seat trim element according to the invention, designed as a three-dimensionally shaped seat cover element and/or three-dimensionally shaped seat upholstery element of a vehicle seat, comprises at least one three-dimensionally shaped insert (also called a 3D add-on module or 3D insert or 3D trim module) produced by a thermoforming process, which can be attached or detachably attached to the seat trim element.

The fact that the insert can be three-dimensionally pre-shaped and detachably and thus interchangeably attached to the three-dimensionally shaped seat trim element reduces seam lines. In addition, complex areas of the seat trim element, such as concave trim areas, trim recesses or the like, can be pre-shaped three-dimensionally and detachably attached to the seat trim element in a simple manner or retrofitted to existing seat trim elements.

A thermoforming process refers in particular to the thermoforming of materials, in particular plastics materials, for example plastics fiber materials, using pressure and heat and/or high-frequency welding (also known as HF welding). The thermoforming process can be carried out in a forming tool formed of two tool halves, for example, to produce a three-dimensional design of the insert or add-on module.

An outer side of the three-dimensionally shaped insert can, for example, be designed as an ornamental surface or at least partially decoratively. An inner side of the three-dimensionally shaped insert can, for example, be designed as a support element or a fastening element. Alternatively or additionally, one or more fastening element(s), for example push-in tabs and/or sewing tabs, can be provided on the three-dimensionally shaped insert.

The three-dimensionally shaped insert can, in particular, be formed from a three-dimensionally deformable and/or compressible and/or solidifiable and/or stabilizable material, in particular a fiber material, in particular a non-woven plastics material or another suitable plastics fiber material. For example, the three-dimensionally shaped insert can have a material thickness of between 1 mm and 5 mm, in particular between 2 mm and 3 mm. In particular, the three-dimensionally shaped insert can be inherently rigid, in particular formed from such a material and/or can have such a material thickness that this insert is inherently rigid.

For example, the three-dimensionally shaped insert can have a material structure, at least one three-dimensionally deformable plastics nonwoven (also called a nonwoven) or similar material, in particular a 3D-shapeable plastics material, for example polymer fiber material, such as a polyester fiber material, polyethylene fiber material, wherein the three-dimensionally deformable plastics material is compressed in its material thickness by three-dimensional deformation and stabilized in a three-dimensional shape. The material may also contain fibers with a low melting point.

Another possibility is a material structure having one or more layers, in particular with surface layers and/or carrier layers, for example made of additional surface material or carrier material. In this case, the surface layers can be fixed to the carrier material with an adhesive layer. The adhesive layer can be pre-fixed to a raw material of the carrier layer or the surface layer or can be formed as a separate material layer. Alternatively, the three-dimensionally shaped insert can be formed from just a single layer of material, in particular a layer of non-woven material or a layer of plastics material, which simultaneously forms the outer side and inner side. For example, the insert can be three-dimensionally pre-shaped (thermoformed) and an upper surface can be formed from a cover material, in particular vinyl, fabric and/or leather and/or a molded-in embossing, and a lower surface can be formed from a three-dimensionally shaped fiber material, in particular plastics fiber material, to form part of a three-dimensionally shaped trim.

The three-dimensionally shaped insert can be, for example, a three-dimensionally shaped cushion insert, in particular a three-dimensionally shaped seat cushion element and/or three-dimensionally shaped seat cover element, a three-dimensionally shaped shoulder support element and/or three-dimensionally shaped neck support element and/or a three-dimensionally shaped armrest recess and/or a three-dimensionally shaped armrest element.

The seat trim element can, for example, be a three-dimensionally shaped seat upholstery element or a three-dimensionally shaped seat covering element.

The insert can be, for example, a seat back insert (also known as a seat back panel), a shoulder insert (also known as a shoulder panel), a neck insert (also known as a neck panel), an armrest insert (also known as an armrest panel), a seat side insert (also known as a seat side panel) or a fastening insert (also known as a fastening panel).

The vehicle seat according to the invention comprises at least one supporting structure and a seat trim element arranged on the supporting structure, as described above.

The seat trim element can be a seat cushion trim element, a seat back trim element, a seat headrest trim element and/or a seat armrest trim element.

In other words: In summary, the invention provides a cushion insert (also known as an insert) that is 3D-shaped using a thermoforming process and can be attached to the seat trim element. The cushion insert can be manufactured, for example, by HF welding technology or other thermoforming technologies. A 3D-pre-shaped center seat cushion insert can be part of the automotive upholstery cover for the second row or third row rear seat cushions in a vehicle. The insert replaces at least part of the regular seat cover. It can be sewn into the seat cover or attached in some other way. The three-dimensionally pre-shaped insert can also be removable and and replaceable to allow for ease of maintenance personalization/modularity.

The 3D-pre-shaping of the insert reduces seam lines. In addition, complex areas of the seat trim element can be realized by 3D-pre-shaping of the insert, for example indentations for storage, such as bottle holders.

The invention can provide storage options, for example holders for mobile devices or other parts, in the insert and in particular can mold them in. The material structure comprises at least one 3D-shapeable nonwoven or similar material, which is compressed in its material thickness by 3D-pre-shaping and stabilized in a 3D shape. The material can also contain fibers with a low melting point. Another possibility is a material structure having one or more layers of additional surface material. In this case, the surface material layers are fixed to the carrier material with an adhesive layer. The adhesive layer can be pre-fixed to the raw material or can appear as a separate material layer.

### DESCRIPTION OF THE FIGURES

In the following, the invention is explained in greater detail with reference to exemplary embodiments shown in the figures. However, the invention is not limited to these exemplary embodiments. In the figures:

FIG. 1: shows a schematic representation of a vehicle seat with a longitudinal adjustment device according to the prior art,

FIG. 2: shows an exploded view of three-dimensionally shaped inserts and for seat trim elements of a row of seats, shown in a perspective view,

FIG. 3: shows a side view of the row of seats according to FIG. 2,

FIG. 4: shows a plan view of the row of seats according to FIG. 2,

FIG. 5: shows a view from the front of the row of seats according to FIG. 2,

FIG. 6: shows a perspective view of an alternative row of seats,

FIG. 7: shows an enlarged perspective view of the alternative row of seats according to FIG. 6 in the region of an insert formed as a fastening insert,

FIG. 8: shows a further enlarged perspective view of the alternative row of seats according to FIG. 6 in the region of the insert formed as a fastening insert, and

FIG. 9: shows a view from the front of the alternative row of seats according to FIG. 6.

### DETAILED DESCRIPTION

Corresponding parts are provided with like reference signs in all figures.

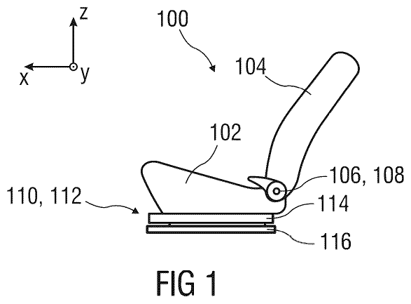

A vehicle seat 100 shown schematically in FIG. 1 relating to the prior art is described below using three spatial directions running perpendicular to each other. In a vehicle seat 100 installed in the vehicle, a longitudinal direction x runs largely horizontally and preferably parallel to a longitudinal direction of the vehicle, which corresponds to the usual direction of travel of the vehicle. A transverse direction y running perpendicular to the longitudinal direction x is also horizontally aligned in the vehicle and runs parallel to a transverse direction of the vehicle. A vertical direction z runs perpendicular to the longitudinal direction x and perpendicular to the transverse direction y. In the case of a vehicle seat 100 installed in the vehicle, the vertical direction z preferably runs parallel to a vehicle vertical axis.

The position information and directional information used, such as front, rear, top and bottom, refer to a viewing direction of an occupant sitting in the vehicle seat 100 in a normal sitting position, wherein the vehicle seat 100 is installed in the vehicle, in a position of use suitable for passenger transportation with the backrest 104 upright and aligned, as is usual, in the direction of travel. However, the vehicle seat 100 can also be installed or moved in a different orientation, for example transverse to the direction of travel. Unless otherwise described, the vehicle seat 100 is constructed with mirror symmetry with respect to a plane extending perpendicular to the transverse direction y.

The backrest 104 can be pivotably arranged on a seat part 102 of the vehicle seat 100. For this purpose, the vehicle seat 100 can optionally comprise a fitting 106, in particular an adjustment fitting, swivel fitting, latching fitting or wobble fitting.

The positional and directional indications used, such as radial, axial and circumferentially, refer to an axis of rotation 108 of the fitting 106. Radial means perpendicular to the axis of rotation 108. Axial means in the direction of or parallel to the axis of rotation 108.

The vehicle seat 100 can optionally comprise a longitudinal adjustment device 110. The longitudinal adjustment device 110 comprises, for example, a rail arrangement 112 with a first rail element 114 and a second rail element 116. The first rail element 114 is adjustable relative to the second rail element 116 in the longitudinal direction x. The first rail element 114 is attached to the seat part 102. The second rail element 116 is attached to a structural element of a vehicle, for example a vehicle floor.

For the sake of clarity, the first rail element 114 is referred to as the top rail 114 in the following description. This top rail 114 (also referred to as a running rail or slide) is associated with the vehicle seat 100 and is designed to support this vehicle seat 100. The second rail element 116 is referred to hereinafter as the bottom rail 116. The bottom rail 116 is fixed and connected, for example, to the floor of a vehicle.

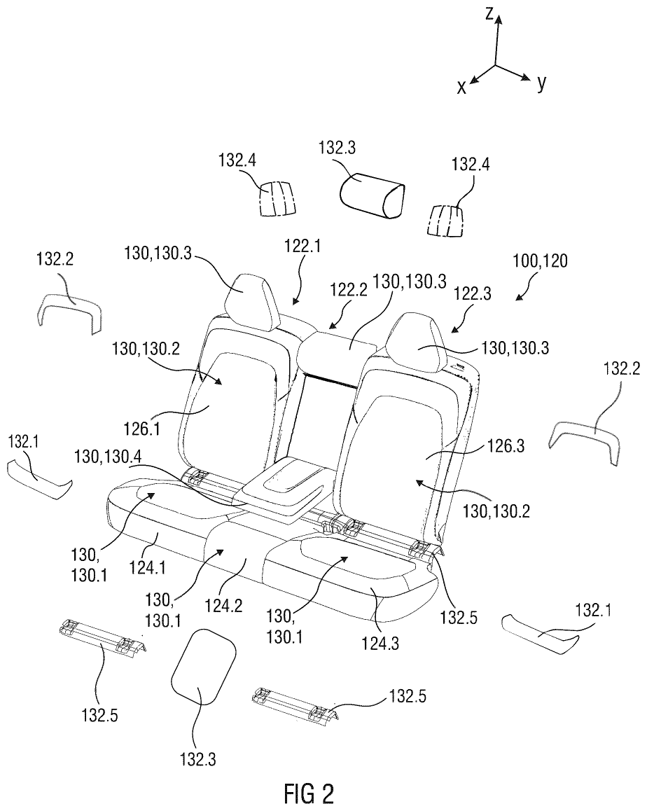

FIG. 2 shows the vehicle seat 100 as a row of seats 120 with several seat portions 122.1 to 122.3, in a perspective view. Instead of the row of seats 120, the vehicle seat 100 can also be designed as a single seat (not shown in detail). In particular, the row of seats 120 can be arranged at the rear of a vehicle.

In the example shown, the row of seats 120 comprises two outer, in particular wider, seat portions 122.1 and 122.3 and a central, in particular narrow, seat portion 122.2.

The respective seat portion 122.1 to 122.3 each comprises a seat surface portion 124.1 to 124.3 (analogous to the seat part 102 in FIG. 1) and a backrest portion 126.1 to 126.3 (analogous to the backrest 104 in FIG. 1). The seat surface portions 124.1 to 124.3 can be formed as a continuous seat bench. Alternatively, the seat surface portions 124.1 to 124.3 can also be formed as divided seat surfaces (not shown). The backrest portions 126.1 to 126.3 can be designed as divided, in particular separately adjustable backrests 104.

The row of seats 120 shown as an example in FIG. 2 comprises three-dimensionally shaped seat trim elements 130. The three-dimensionally shaped seat trim elements 130 can be designed as a three-dimensionally shaped seat covering element or a three-dimensionally shaped seat upholstery element, s described by way of example in DE 10 2018 202 153 A1 or in WO 2019/155046 A1.

The seat trim element 130 can be, for example, a seat cushion trim element 130.1, a seat back trim element 130.2, a seat headrest trim element 130.3 and/or a seat armrest trim element 130.4.

The seat trim elements 130 are arranged and held, in a manner not shown in detail, on a supporting structure of the respective seat portion 122.1 to 122.3.

According to the invention, the vehicle seat 100 formed as a row of seats 120 comprises a number of three-dimensionally shaped inserts 132.1 to 132.5. The inserts 132.1 to 132.5 are three-dimensionally shaped in a thermoforming process. The inserts 132.1 to 132.5 are attachable to the respective associated seat trim element 130, in particular are detachably or interchangeably attached.

The respective three-dimensionally shaped insert 132.1 to 132.5 produced by a thermoforming process is also referred to as 3D add-on module or 3D insert or 3D trim module.

The fact that the respective insert 132.1 to 132.5 is three-dimensionally pre-shaped and can be detachably and thus interchangeably attached to the associated three-dimensionally shaped seat trim element 130 reduces seam lines.

In particular, the thermoforming process is understood to mean a thermoforming of materials, in particular plastics materials, for example plastics fiber materials, with the aid of pressure and heat and/or high-frequency welding (also referred to as HF welding). The thermoforming process can be carried out in a forming tool formed, for example, from two tool halves for producing a three-dimensional configuration of the respective insert 132.1 to 132.5.

The respective insert 132.1 to 132.5 can, for example, be pre-shaped, in particular thermoformed, by the thermoforming process and can have an upper surface made of a covering material, in particular of vinyl, fabric and/or leather optionally with a molded-in embossing. A lower surface of the respective insert 132.1 to 132.5 may be formed from a three-dimensionally shaped fiber material to form part of a three-dimensionally shaped trim.

An outer side of the respective three-dimensionally shaped insert 132.1 to 132.5 can, for example, be designed as an ornamental surface or at least partially decoratively. An inner side of the respective three-dimensionally shaped insert 132.1 to 132.5 may, for example, be designed as a support element or a fastening element. Alternatively or additionally, one or more fastening element(s), for example push-in tabs and/or sewing tabs, can be provided on the respective three-dimensionally shaped insert 132.1 to 132.5.

The respective three-dimensionally shaped insert 132.1 to 132.5 may in particular be formed from a three-dimensionally deformable and/or compressible and/or solidifiable and/or stabilizable material, in particular a fiber material, in particular a non-woven plastics material or another suitable plastics fiber material. For example, the respective three-dimensionally shaped insert 132.1 to 132.5 can have a material thickness of between 1 mm and 5 mm, in particular between 2 mm and 3 mm.

The respective three-dimensionally shaped insert 132.1 to 132.5 can also have a contoured material structure, at least one three-dimensionally deformable plastics nonwoven (also called nonwoven) or similar material, in particular a 3D-shapeable plastics material, for example polymer fiber material, such as a polyester fiber material, polyethylene fiber material, wherein the three-dimensionally deformable plastics material is compressed in its material thickness by three-dimensional deformation and stabilized in a three-dimensional shape. The material may additionally contain fibers having a low melting point.

A first three-dimensionally shaped insert 132.1 may be, for example, a seat surface insert (also referred to as a seat surface panel), for example a three-dimensionally shaped front cushion insert, in particular a three-dimensionally shaped seat surface cushion element and/or three-dimensionally shaped seat surface cover element, for a front seat surface portion 124.1 and 124.3. The first three-dimensionally shaped insert 132.1 serves, for example, to support the thigh region of a user or occupant seated in said seat portion 122.1 and 122.3. The first three-dimensionally shaped insert 132.1 can be detachably or interchangeably connected, for example sewn, clipped or the like, to the associated seat cushion trim element 130.1.

A second three-dimensionally shaped insert 132.2 may in particular be a shoulder insert (also referred to as a shoulder panel), for example a three-dimensionally shaped shoulder support element, a seat back insert (also referred to as a seat back panel) and/or a neck insert (also referred to as a neck panel), for example a three-dimensionally shaped neck support element. The second three-dimensionally shaped insert 132.2 may be detachably or interchangeably connected, for example sewn, clipped or the like, to the associated seat back trim element 130.2.

A third three-dimensionally shaped insert 132.3 can in particular be an armrest insert (also called an armrest panel), for example a three-dimensionally shaped armrest recess and/or a three-dimensionally shaped armrest element with holding receptacles for utensils. The third three-dimensionally shaped insert 132.3 can be detachably or interchangeably connected, for example sewn, clipped or the like, to the associated seat armrest trim element 130.4.

A fourth three-dimensionally shaped insert 132.4 may in particular be a headrest insert (also called a headrest panel), for example a three-dimensionally shaped, in particular ergonomically shaped, head support. The fourth three-dimensionally shaped insert 132.4 can be detachably or interchangeably connected, for example sewn, clipped or the like, to the associated seat headrest trim element 130.3.

A fifth three-dimensionally shaped insert 132.5 may in particular be a cover insert for a fastening (also called a cover panel), for example a three-dimensionally shaped cover strip with apertures for an ISO-fix fastening. The fifth three-dimensionally shaped insert 132.5 can be detachably or interchangeably connected, for example sewn, clipped or the like, to the adjacent seat back trim element 130.2 and/or the adjacent seat cushion trim element 130.1.

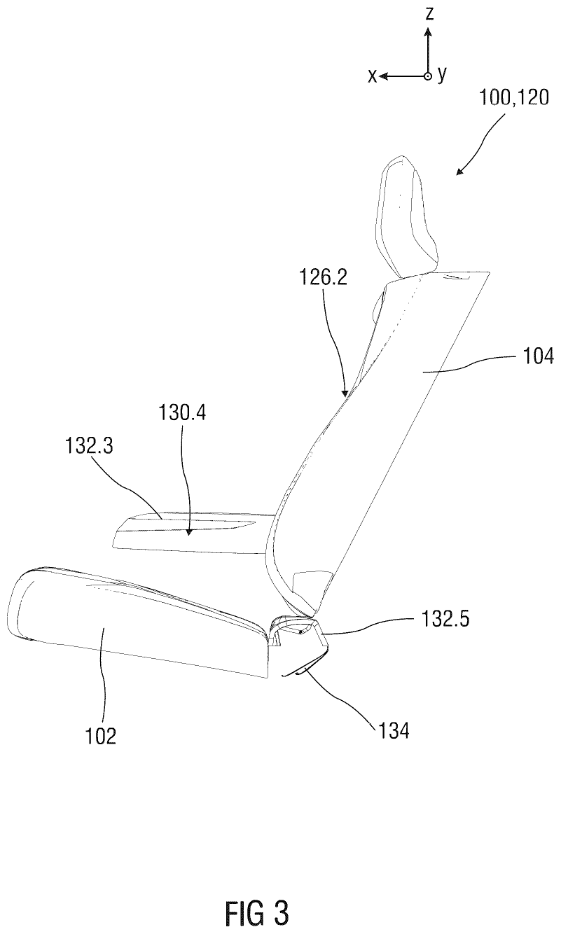

FIG. 3 shows a side view of the seat row 120 according to FIG. 2. The fifth three-dimensionally shaped insert 132.5 is arranged between the backrest 104 and the seat part 102. In addition, a spring plate 134 may be integrally formed on or attached to the insert 132.5.

The central backrest portion 126.2 forming an armrest can, for example, be formed in several parts. The backrest portion 126.2 can, for example, comprise a fixed backrest 104 and a seat armrest trim element 130.4 pivotably arranged on this backrest 104. In turn, an armrest insert (third three-dimensionally shaped insert 132.3) may be detachably or interchangeably attachable to or in this seat armrest trim element 130.4. For example, an armrest recess with a cup holder and/or holder for electronic devices is detachably arranged on the inside of the seat armrest trim element 130.4 as a third three-dimensionally shaped insert 132.3.

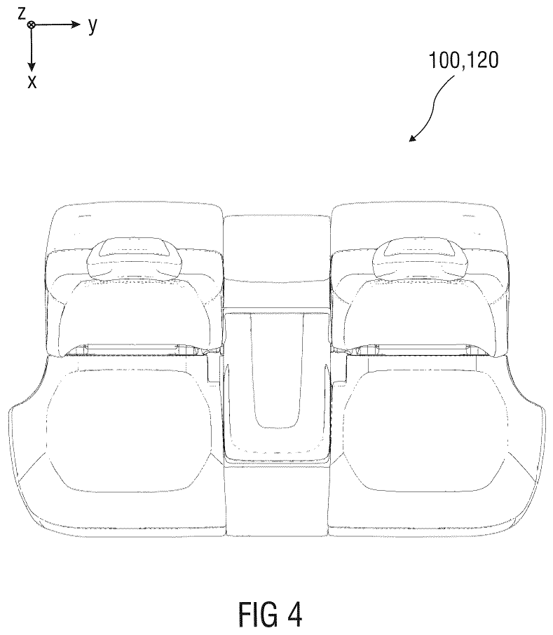

FIG. 4 shows a plan view of the row of seats 120 shown in FIG. 2.

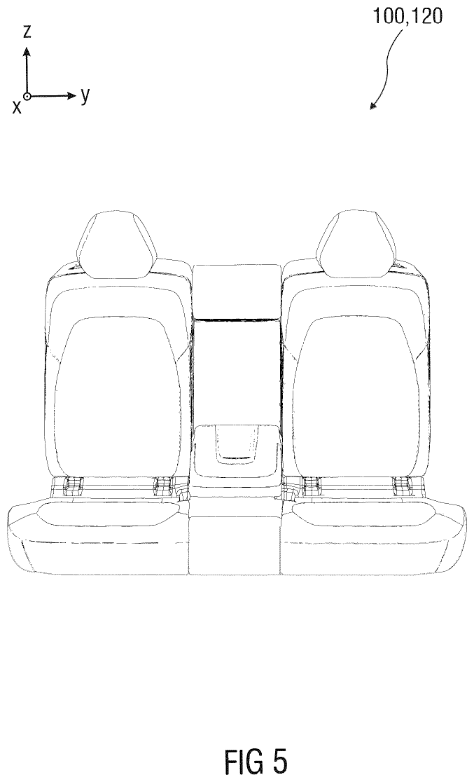

FIG. 5 shows a view from the front of the row of seats 120 shown in FIG. 2.

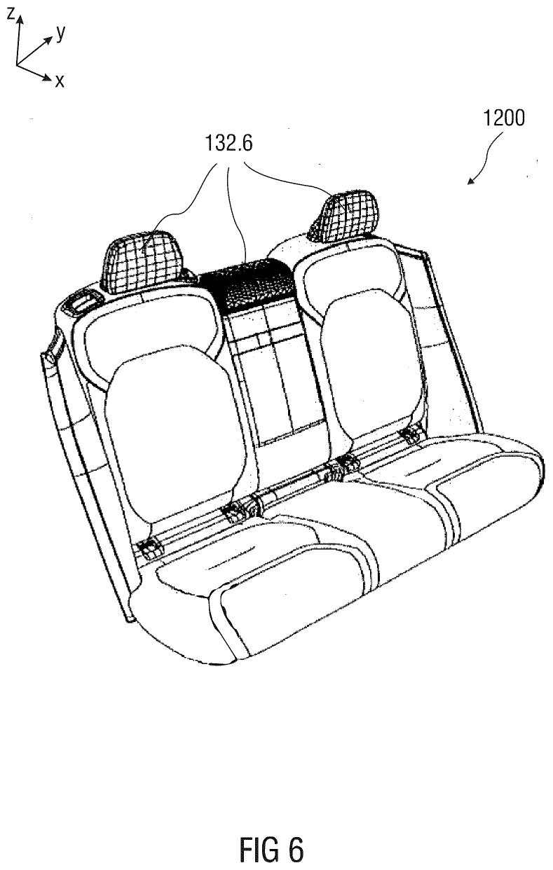

FIG. 6 shows a perspective view of an alternative row of seats 1200.

The row of seats 1200 differs from the row of seats 120 only in the type of a sixth insert 132.6 for the seat headrest trim element 130.3 and the seat back trim element 130.2 (shown in FIG. 2). In the example shown, the sixth insert 132.6 has a surface profile, for example for an improved ergonomic contact surface. Analogously to the previously described inserts 132.1 to 132.2, the sixth insert 132.6 is three-dimensionally pre-shaped by the thermoforming process and additionally provided with a surface embossing.

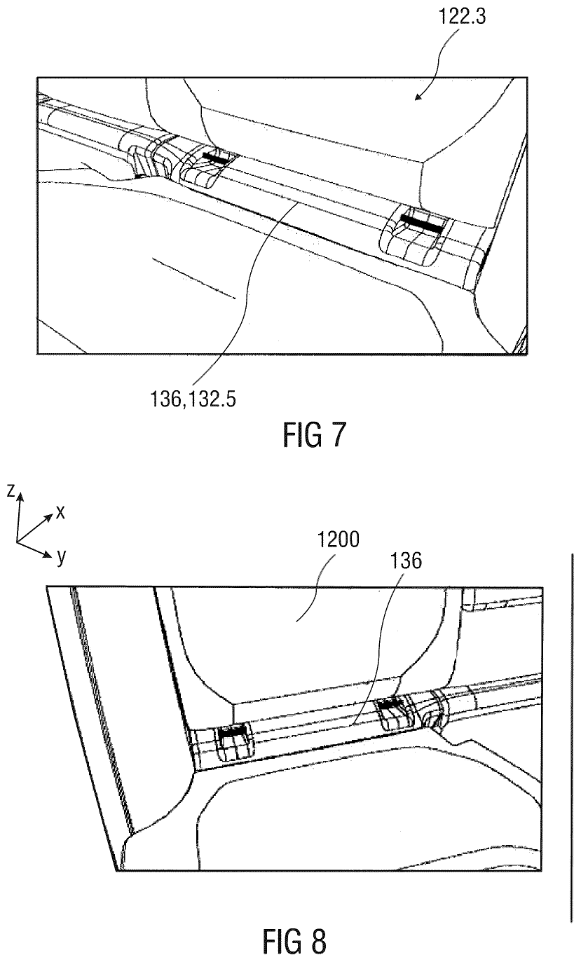

FIG. 7 shows an enlarged perspective view of the alternative row of seats 1200 according to FIG. 6 in the region of a fifth insert 132.5 (also shown in FIG. 2) formed as a cover insert 136 for covering an ISO-fix fastening in the relevant seat portion 122.3.

FIG. 8 shows a further enlarged perspective view of the alternative row of seats 1200 according to FIG. 6 in the region of the cover insert 136.

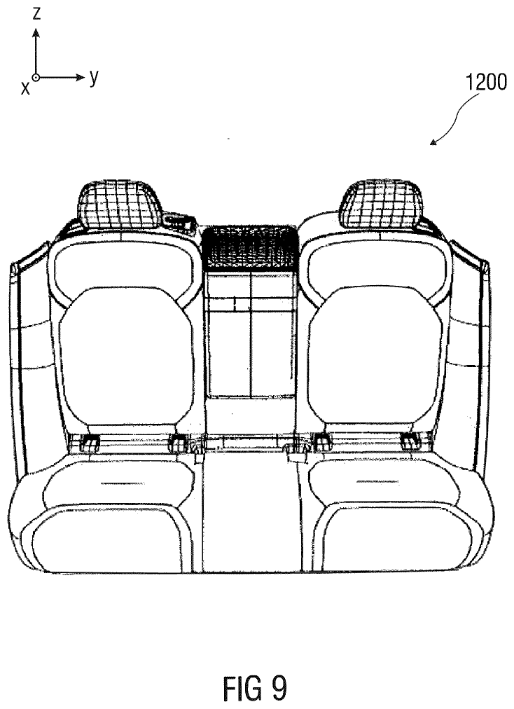

FIG. 9 shows a view from the front of the alternative row of seats 1200 shown in FIG. 6.

### LIST OF REFERENCE SIGNS

100 vehicle seat
102 seat part
104 backrest
106 fitting
108 axis of rotation
110 longitudinal adjustment device
112 rail arrangement
114 first rail element (top rail)
116 second rail element (bottom rail)
120 row of seats
122.1 to 122.3 seat portion
124.1 to 124.3 seat portion
126.1 to 126.3 backrest portion
130 seat trim element
130.1 seat cushion trim element
130.2 seat backrest trim element
130.3 seat headrest trim element
130.4 seat armrest trim element
132.1 to 132.6 first insert to sixth insert
134 spring plate
136 covering insert
1200 row of seats
x longitudinal direction
y transverse direction
z vertical direction

What is claimed is:

1. A seat trim element, formed as a three-dimensionally shaped seat cover element and/or three-dimensionally shaped seat upholstery element of a vehicle seat,
wherein at least one three-dimensionally shaped insert produced by a thermoforming process is provided, which can be attached or is detachably or interchangeably attached to the seat trim element.

2. The seat trim element as claimed in claim 1,
wherein the insert is three-dimensionally shaped by a pressure thermoforming process or by high-frequency welding of plastics fibers.

3. The seat trim element as claimed in claim 1,
wherein the three-dimensionally shaped insert is a three-dimensionally shaped cushion insert.

4. The seat trim element as claimed in claim 1,
wherein the three-dimensionally shaped insert is a three-dimensionally shaped shoulder support element and/or a three-dimensionally shaped neck support element.

5. The seat trim element as claimed in claim 1,
wherein the three-dimensionally shaped insert is a three-dimensionally shaped armrest recess and/or a three-dimensionally shaped armrest element.

6. The seat trim element as claimed in claim 1,
further comprising a three-dimensionally shaped seat cushion element or a three-dimensionally shaped seat covering element.

7. The seat trim element as claimed in claim 1,
wherein the insert is three-dimensionally pre-shaped and an upper surface is formed of a covering material, comprising vinyl, fabric and/or leather and/or a molded-in embossing, and a lower surface is formed of a three-dimensionally shaped fiber material to form part of a three-dimensionally shaped trim.

8. A vehicle seat,
which comprises:
a supporting structure and
a seat trim element arranged on the supporting structure as claimed in claim 1.

9. The vehicle seat as claimed in claim 8,
wherein the seat trim element is a seat cushion trim element, a seat backrest trim element, a seat headrest trim element or a seat armrest trim element.
